(19) United States
(12) Patent Application Publication
(10) Pub. No.: US 2008/0207256 A1
(43) Pub. Date: Aug. 28, 2008

(54) Concurrent impedance matching of a wireless transceiver

(75) Inventor: Alan Ngar Loong Chan, San Jose, CA (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/710,197

(22) Filed: Feb. 22, 2007

(51) Int. Cl. H04M 1/00

(52) U.S. Cl. 455/550.1

(57) ABSTRACT

A system and method of concurrent impedance matching of a wireless transceiver is disclosed. In one embodiment, an impedance matching circuit of a wireless transceiver includes a low noise amplifier (LNA) circuit to amplify an input signal to the wireless transceiver during a reception mode of the wireless transceiver, a power amplifier (PA) circuit to amplify an output signal of the wireless transceiver during a transmission mode of the wireless transceiver, and a matching circuit to concurrently match an impedance of the low noise amplifier circuit and the power amplifier circuit with an impedance of an antenna circuit associated with the wireless transceiver such that a power of the input signal is maximized during the reception mode and a power of the output signal is maximized during the transmission mode.

### FIELD OF TECHNOLOGY

This disclosure relates generally to the technical fields of telecommunications, in one embodiment, to a system and method of concurrent impedance matching of a wireless transceiver.

### BACKGROUND

In electrical engineering, the maximum power (transfer) theorem states that, to obtain maximum power from a source with a fixed internal impedance, an impedance of a load may be made the same as that of the source. Accordingly, in radio, transmission lines, and/or other electronics, there may be often a requirement to match the impedance of the source (e.g., a transmitter and/or a receiver) to the impedance of the load (e.g. an antenna) to avoid reflections in the radio, transmission line and/or other electronics.

In most wireless standards (e.g., especially in TDD systems), a transmit/receive (T/R) switch may be used to isolate a transmit (Tx) path from a receive (Rx) path in a transceiver before connecting to an antenna. Such an isolation scheme means that both a low noise amplifier (e.g., of the receive path) and/or a power amplifier (e.g., of the transmit path) may have a matching circuit of its own to a predefined system impedance (e.g., which is typically 50 Ohms).

Normally, GaAs and/or pHEMT devices may be used for the T/R switch due to their low loss (e.g. less than 1 dB) and/or high linearity (e.g., OP_{1dB}>30 dBm), combined with a CMOS transceiver to form a system solution. However, the T/R switch may become a burden to a true single chip integration to achieve a smaller size system. A CMOS T/R switch may possess an acceptable performance with a loss less than 2 dB and/or a moderate linearity (e.g. OP_{1dB}>20 dBm) at few gigahertz range. However, the acceptable performance of the CMOS T/R switch may be marginal for a system (e.g., the transceiver) which may require a low noise figure (NF) for a certain signal-to-noise (SNR) ratio.

For example, an ultra wide band (UWB) system may require the noise figure of 6.3 dB for the system to perform properly. With the loss of 2 dB of the CMOS T/R switch, the noise figure of the system may have to be less than 4.3 dB (e.g., which means that a power of the system has to be increased to accommodate the loss of the CMOS T/R switch). Furthermore, a linearity of the CMOS T/R switch may be degraded as a maximum supply voltage of the system (e.g., in a chip) is reduced due to a decrease in a size of the system (e.g., owing to a scaling down of process technology).

### SUMMARY OF THE DISCLOSURE

A system and method of concurrent impedance matching of a wireless transceiver is disclosed. In one aspect, an impedance matching circuit of a wireless transceiver includes a low noise amplifier (LNA) circuit to amplify an input signal to the wireless transceiver during a reception mode of the wireless transceiver, a power amplifier (PA) circuit to amplify an output signal of the wireless transceiver during a transmission mode of the wireless transceiver, and a matching circuit (e.g., which includes two capacitors, a first inductor coupled to the two capacitors in parallel, and a second inductor coupled to the two capacitors in series) to concurrently match an impedance of the low noise amplifier circuit and the power amplifier circuit with an impedance (e.g., 50 ohms) of an antenna circuit associated with the wireless transceiver such that a power of the input signal is maximized during the reception mode and a power of the output signal is maximized during the transmission mode.

An input transistor of the low noise amplifier circuit and an inductor coupled to the input transistor may form a real part of the 50 ohms. An inductance due to a package bondwire of the wireless transceiver may be considered in selecting the two capacitors, the first inductor, and the second inductor. The impedance matching circuit may also include a first digital switch of the low noise amplifier circuit to reduce a gain of the low noise amplifier circuit due to the output signal of the power amplifier circuit strayed to the low noise amplifier circuit (e.g., which may draw less than 1 mili-amp of the output signal) during the transmission mode through closing the first digital switch. In addition, the impedance matching circuit may include a second digital switch of the power amplifier circuit to reduce the output signal of the power amplifier circuit strayed to the low noise amplifier circuit when the second digital switch is closed during the transmission mode. The low noise amplifier circuit may be substantially isolated from the power amplifier circuit when the first digital switch and the second digital switch are closed during the transmission mode. Moreover, the power amplifier circuit in an off-state may be substantially isolated from the low noise amplifier circuit during the reception mode when an impedance of the power amplifier circuit approaches an extremely high value relative to an impedance of the low noise amplifier.

In another aspect, a method of a wireless transceiver includes amplifying a transmit signal by processing the transmit signal through a power amplifier during a transmission mode, amplifying a received signal by processing the received signal through a low noise amplifier during a reception mode, and maximizing a power of at least one of the transmit signal and the received signal through simultaneously matching an impedance of the power amplifier and the low noise amplifier with an impedance of an antenna coupled to the wireless transceiver.

The method may further include widening a bandwidth of the wireless transceiver to a higher order without using more circuit components through performing the simultaneously matching the impedance of the power amplifier and the low noise amplifier with the impedance of the antenna, wherein the higher order to include at least the fourth order. Also, the method may include directly feeding the received signal to the low noise amplifier during the reception mode such that a resulting noise figure (e.g., between 4 dB and 5 dB) of the wireless transceiver which is not generated by the low noise amplifier is significantly reduced. A gain of the low noise amplifier during the reception mode may be about 28 dB. In addition, the method may include directly communicating the transmit signal to the antenna during the transmission mode such that a higher gain is achieved with a minimal loss at the power amplifier during the transmission mode. An output 1 dB compression point during the transmission mode may be greater than −3 dB. Furthermore, the method may include decreasing a power consumption of the wireless transceiver by at least 5 percent through performing the simultaneously matching the impedance of the power amplifier and the low noise amplifier with the impedance of the antenna coupled to the wireless transceiver.

In yet another aspect, a system of a wireless transceiver includes a transmission circuit having a power amplifier (PA) to communicate a transmit signal of the wireless transceiver during a transmission mode of the wireless transceiver, a reception circuit having a low noise amplifier (LNA) to communicate a received signal to the wireless transceiver during a reception mode of the wireless transceiver, and a matching circuit to perform at least one of matching an impedance of the power amplifier with an impedance of an antenna of the wireless transceiver during the transmission mode to maximize a power of the transmit signal and matching an impedance of the low noise amplifier with the impedance of the antenna to maximize a power of the received signal.

In addition, at least one of the power amplifier, the low noise amplifier, and the matching circuit may have a combination of capacitors and inductors such that the impedance of the power amplifier, the impedance of the low noise amplifier, and the impedance of the matching circuit are easily configurable.

The methods, systems, and devices disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system diagram of a wireless transceiver, according to one embodiment.

FIG. 2 is a system diagram of the Low Noise Amplifier (LNA) of the wireless transceiver of FIG. 1, according to one embodiment.

FIG. 3 is a system diagram of the Power Amplifier (PA) of the wireless transceiver of FIG. 1, according to one embodiment.

FIG. 4 is a system diagram of the matching circuit of the wireless transceiver of FIG. 1, according to one embodiment.

FIG. 5 is a circuit diagram of the matching circuit of FIG. 1 connected with the low noise amplifier and the power amplifier, according to one embodiment.

FIG. 6 is a process flow chart of maximizing a power of a signal processed through the wireless transceiver of FIG. 1 by an impedance matching, according to one embodiment.

Other features of the present embodiments will be apparent from the accompanying drawings and from the detailed description that follows.

### DETAILED DESCRIPTION

A system and method of concurrent impedance matching of a wireless transceiver is disclosed. In the following description, for the purposes of explanation, numerous specific details are set forth in order to provide a thorough understanding of the various embodiments. It will be evident, however to one skilled in the art that the various embodiments may be practiced without these specific details.

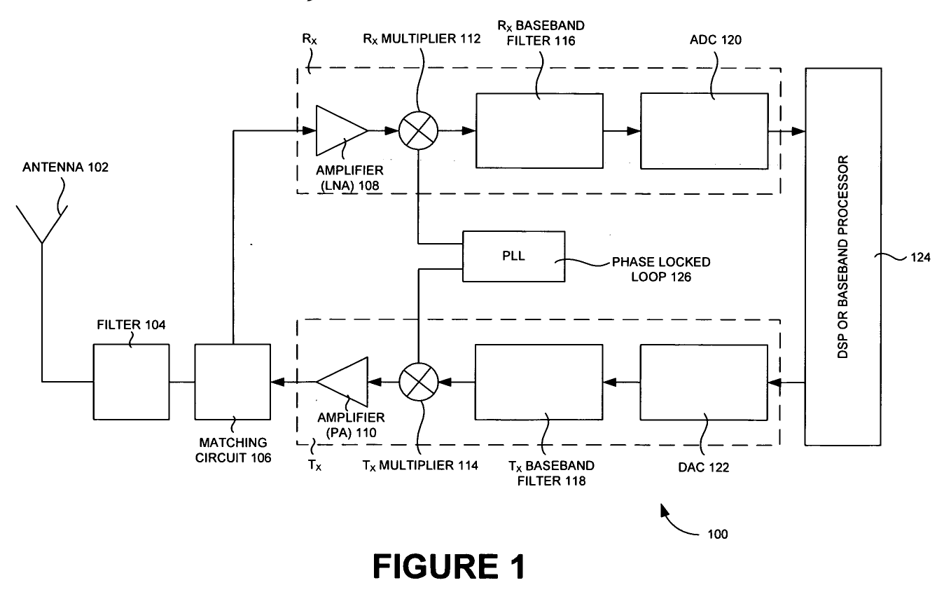

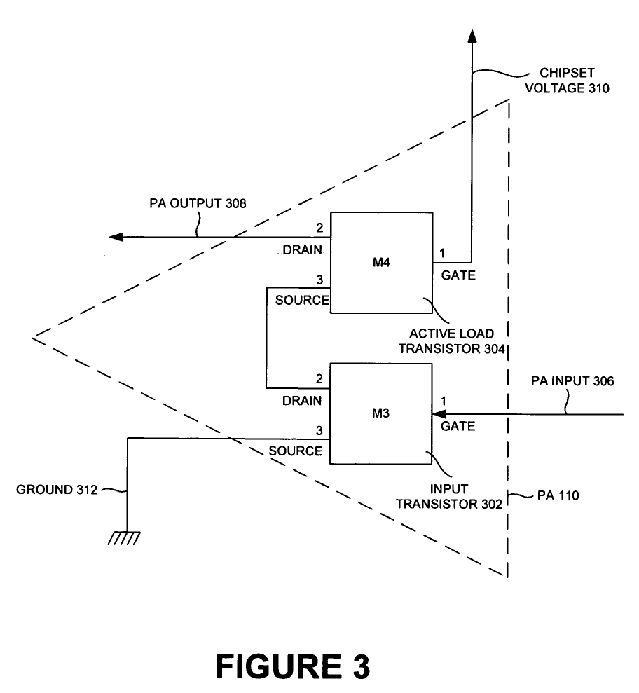

In one embodiment, an impedance matching circuit of a wireless transceiver (e.g., the wireless transceiver 100 of FIG. 1) includes a low noise amplifier (LNA) circuit (e.g., the LNA 108) to amplify an input signal (e.g., a LNA input 212) to the wireless transceiver during a reception mode of the wireless transceiver, a power amplifier (PA) circuit (e.g., a power amplifier 108) to amplify an output signal (e.g., a PA output 308 of FIG. 3) of the wireless transceiver during a transmission mode of the wireless transceiver, and a matching circuit (e.g., a matching circuit 106) to concurrently match an impedance of the low noise amplifier and the power amplifier with an impedance of an antenna circuit (e.g., an antenna 102) associated with the wireless transceiver such that a power of the input signal is maximized during the reception mode and a power of the output signal is maximized during the transmission mode.

In another embodiment, a method of a wireless transceiver includes amplifying a transmit signal by processing the transmit signal through a power amplifier during a transmission mode, amplifying a received signal by processing the received signal through a low noise amplifier during a reception mode, and maximizing a power of at least one of the transmit signal and the received signal through simultaneously matching an impedance of the power amplifier and the low noise amplifier with an impedance of an antenna coupled to the wireless transceiver.

In yet another embodiment, a system of a wireless transceiver includes a transmission circuit having a power amplifier (PA) to communicate a transmit signal of the wireless transceiver during a transmission mode of the wireless transceiver, a reception circuit having a low noise amplifier (LNA) to communicate a received signal to the wireless transceiver during a reception mode of the wireless transceiver, and a matching circuit to perform at least one of matching an impedance of the power amplifier with an impedance of an antenna of the wireless transceiver during the transmission mode to maximize a power of the transmit signal and matching an impedance of the low noise amplifier with the impedance of the antenna to maximize a power of the received signal.

FIG. 1 is a system diagram of a wireless transceiver 100, according to one embodiment. Particularly, FIG. 1 illustrates the wireless transceiver 100 having an antenna 102, a filter 104, an matching circuit 106, a Low Noise Amplifier (LNA) 108, a Power Amplifier (PA) 110, a Rx multiplier 112, a Tx multiplier 114, a Rx baseband filter 116, a Tx baseband filter 118, an analog-to-digital converter (ADC) 120, a digital-to-analog converter (DAC) 122, a DSP or baseband processor 124, and/or a phase-locked loop 126.

The antenna 102 may be an arrangement of aerial electrical conductors that may be designed to transmit and/or receive radio waves which may be a class of electromagnetic waves. The filter 104 may be a filter that may be used to reduce the out of band components of the incoming signal and/or outgoing signal. The matching circuit 106 may be an arrangement of inductors and capacitors that may be used to match the output impedance of the power amplifier 110, and/or the input impedance of the low noise amplifier 108 to the impedance of the antenna 102.

The low noise amplifier 108 may be an amplifier that may be used to amplify a received signal coming from the antenna 102. The power amplifier 110 may be an amplifier that may be used to amplify a transmitted signal coming from the DSP or baseband processor 124. The Rx multiplier 112 may be a multiplier that may be used to shift the received signal coming from the antenna to a baseband signal. The Tx multiplier 114 may be a multiplier that may be used to shift a baseband signal coming from the DSP or baseband processor to a high frequency signal ready to be transmitted.

The analog-to-digital converter 120 may be a device that may convert an analog signal into a digital signal. The digital-to-analog converter 122 may be a device that may convert a digital signal to an analog signal. The DSP or baseband processor 124 may be a processor that may manage all the receiving and transmitting operations in the system. It may also operate the received signals and the transmitted signals.

In one example embodiment, when a signal is received by the antenna 102, it may be filtered by the filter 104. This filtered signal may be input to the matching circuit 106 that may send the signal to the low noise amplifier 108. The low noise amplifier 108 may output an amplified version of this incoming signal. The signal amplified may be input to the Rx multiplier 112 that may shift the amplified signal to a baseband signal. The Rx baseband filter 116 may filter the baseband signal to filter out out-of-band components of the baseband signal. The output of the Rx baseband filter 116 may be converted to a digital signal by the analog-to-digital converter 120. The digital signal may then be operated by the DSP or baseband processor 124.

In one example embodiment, when the DSP or baseband processor 124 transmits a signal, a digital signal of the DSP or baseband processor 124 may be sent to the digital-to-analog converter (DAC) 122 to be converted to an analog signal. The analog signal may be filtered by the Tx baseband filter 118. The analog signal filtered by the Tx baseband filter 118 may be change to a high frequency bandpass signal when the analog signal is processed by the TX multiplier 114. The high frequency signal may be amplified by the Power Amplifier 110. The filter 104 may be used to perform a final filtering of the transmitted signal communicated through the antenna 102. A power consumption of the wireless transceiver may be decreased by at least 5 percent through simultaneously matching the impedance of the power amplifier 110 and/or the low noise amplifier 108 with the impedance of the antenna 102 coupled to the wireless transceiver 100.

In another example embodiment, a transmission circuit having the power amplifier (PA) 110 may communicate a transmit signal of the wireless transceiver 100 during a transmission mode of the wireless transceiver 100. Also, a reception circuit having the low noise amplifier (LNA) 108 may communicate a received signal to the wireless transceiver 100 during a reception mode of the wireless transceiver 100. In addition, the matching circuit 106 may match an impedance of the power amplifier 110 with the impedance of the antenna 102 of the wireless transceiver 100 during the transmission mode to maximize a power of the transmit signal and/or match an impedance of the low noise amplifier 108 with the impedance of the antenna 102 to maximize a power of the received signal. The power amplifier 110, the low noise amplifier 108, and/or the matching circuit 106 may have a combination of capacitors and inductors such that the impedance of the power amplifier 110, the impedance of the low noise amplifier 108, and the impedance of the matching circuit 106 may be easily configurable.

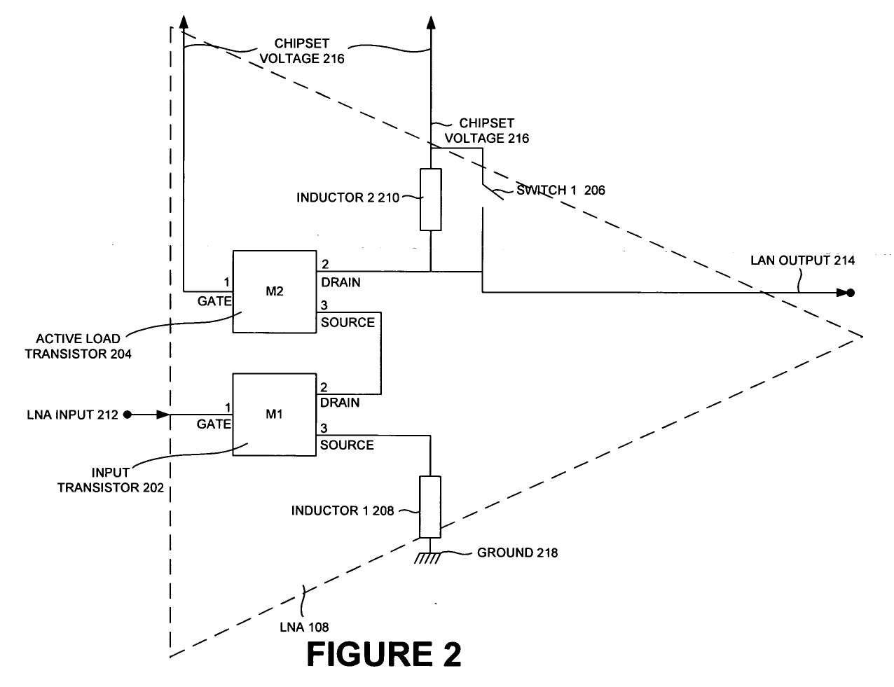

FIG. 2 is a system diagram of the Low Noise Amplifier (LNA) 108 of the wireless transceiver 100 of FIG. 1, according to one embodiment. Particularly, FIG. 2 illustrates the Low Noise Amplifier (LNA) 108 having an input transistor 202, an active load transistor 204, a switch 1 206, an inductor 1 208, an inductor 2 210, a LNA input 212, a LNA output 214, a chipset voltage 216 and a ground 218.

The low noise amplifier 108 may be an amplifier that may be used to amplify the LNA input 212 (e.g., which is a received signal through the antenna 102 of FIG. 1). The input transistor 202 may be an n-channel metal-oxide-semiconductor field-effect transistor (NMOS), a bipolar junction transistor (BJT), and/or a metal-semiconductor field-effect transistor. The input transistor 202 may amplify a signal at its gate to generate an output at its drain. The active load transistor 204 may be an n-channel metal-oxide-semiconductor field-effect transistor (NMOS), a bipolar junction transistor (BJT), and/or a metal-semiconductor field-effect transistor. The active load transistor 204 may act as an impedance (e.g., which may be used by the input transistor 202) to amplify the LNA input 212. The switch 1 206 may be a device to change the course of a circuit. The switch 1 206 may be used to short circuit the inductor 2 210 when the system is in transmission mode.

The inductor 1 208 may be a passive electrical device employed for its property of inductance. The inductor 1 208 may be used to adjust the input impedance of the LNA 108 to a design value. The inductor 2 210 may be a passive electrical device employed for its property of inductance. The inductor 2 210 may be used to adjust the gain of the LNA 108 to a design value. The chipset voltage 216 may be a fixed voltage that may be used to bias some components of the LNA 108.

In one example embodiment, a signal that is fed to the LNA 108 through the LNA input 212 may be amplified by the input transistor 202 if the LNA input 212 is small enough so that the input transistor 202 operates in an amplification mode. The active load transistor 204 together with the inductor 210 may create a load for the input transistor 202 so that the LNA 108 may amplify the LNA input 212 to generate the LNA output 214. The chipset voltage 216 may be set to fixed values so that the active load transistor 204 and/or the input transistor 202 may operate in the amplification mode. The inductor 208 1 may be chosen so that the value of the input impedance of the LNA 108 may be set to a given value. The switch 1 206 may remain open during a reception mode, so that the LNA input 212 may be amplified. During a transmission mode, the switch 1 206 may be closed to reduce the amplification of the LNA 108 and/or help isolate the LNA 108 from other components of the wireless transceiver 100 (e.g., especially from the power amplifier 110).

FIG. 3 is a system diagram of the Power Amplifier (PA) 110 of the wireless transceiver 100 of FIG. 1, according to one embodiment. Particularly, FIG. 3 illustrates the Power Amplifier (PA) 110 having an input transistor 302, an active load transistor 304, a PA input 306, a PA output 308, a chipset voltage 310 and/a ground 312.

The power amplifier 110 may be an amplifier that may be used to amplify the PA input 306. The input transistor 302 may be an n-channel metal-oxide-semiconductor field-effect transistor (NMOS), a bipolar junction transistor (BJT), and/or a metal-semiconductor field-effect transistor. The input transistor 302 may generate an output signal (e.g., amplified) on its drain based on an input signal at its gate. The active load transistor 304 may be an n-channel metal-oxide-semiconductor field-effect transistor (NMOS), a bipolar junction transistor (BJT), and/or a metal-semiconductor field-effect transistor. The active load transistor 304 (e.g., which may act as an impedance) may be used by the input transistor 302 to amplify the PA input 306. The chipset voltage 310 may be a fixed voltage that may be used to bias some components of the PA 110.

In one example embodiment, the PA input 306 may be amplified by the input transistor 302 if this input signal is small enough so that the input transistor 302 operates in an amplification mode. The active load transistor 304 may create a load for the input transistor 302 so that the PA 110 may amplify the PA input 306.

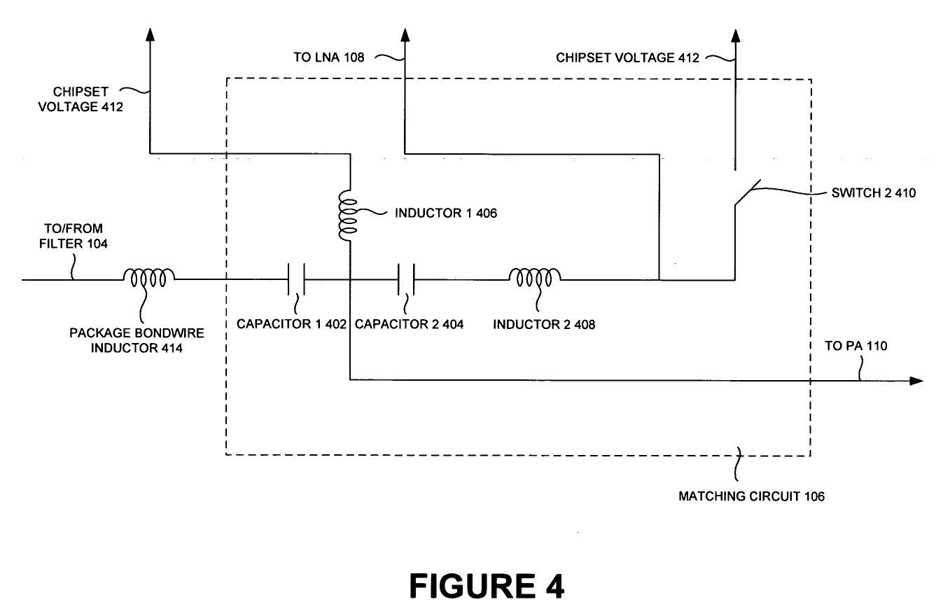

FIG. 4 is a system diagram of the matching circuit 106 of the wireless transceiver 100 of FIG. 1, according to one embodiment. Particularly, FIG. 4 illustrates the matching circuit 106 having a capacitor 1 402, a capacitor 2 404, an inductor 1 406, an inductor 2 408, a switch 2 410, a chipset voltage 412, and a package bondwire inductor 414.

The matching circuit 106 may be a circuit used to match at least one of the output impedance of the PA 110, and/or the input impedance of the LNA 108 with the impedance of the antenna system 102. The capacitor 1 402, the capacitor 2 404, the inductor 1 406 and/or the inductor 2 408 may be used to match an output impedance of the power amplifier and/or the input impedance of the low noise amplifier 108 to the impedance of the antenna 102. The switch 2 410 may be a device to change a course of a circuit. More particularly, the switch 2 410 may be used to connect the inductor 2 408 to the chipset voltage 412 when the transceiver 100 of FIG. 1 is in the transmission mode. The package bondwire inductor 414 may be inherent to the transceiver 100.

In one example embodiment, when the system is in the reception mode, the switch 2 410 may be open. A received signal may be processed through the matching circuit 106 after being treated by the antenna system 102. The received signal may see an open circuit at a path toward the power amplifier 110, hence heading towards a lesser resistive path leading to the LNA 108. The capacitor 1 402, the capacitor 2 404, the inductor 1 406, and/or the inductor 2 408 may be chosen such that an impedance seen by the received signal and/or a transmit signal may be same as the impedance of the antenna 102, to assure a maximum power transfer of the received signal and/or the transmit signal.

During a transmission mode of the wireless transceiver 100, the switch 2 410 may be closed, thus connecting the inductor 2 408 to the chipset voltage 412. This may reduce a current (e.g., a stray current) going to the low noise amplifier 108, and/or increase an isolation of the low noise amplifier 108 (e.g., so that the transmit signal from the power amplifier 110 transmitted out of the antenna 102 may be maximum).

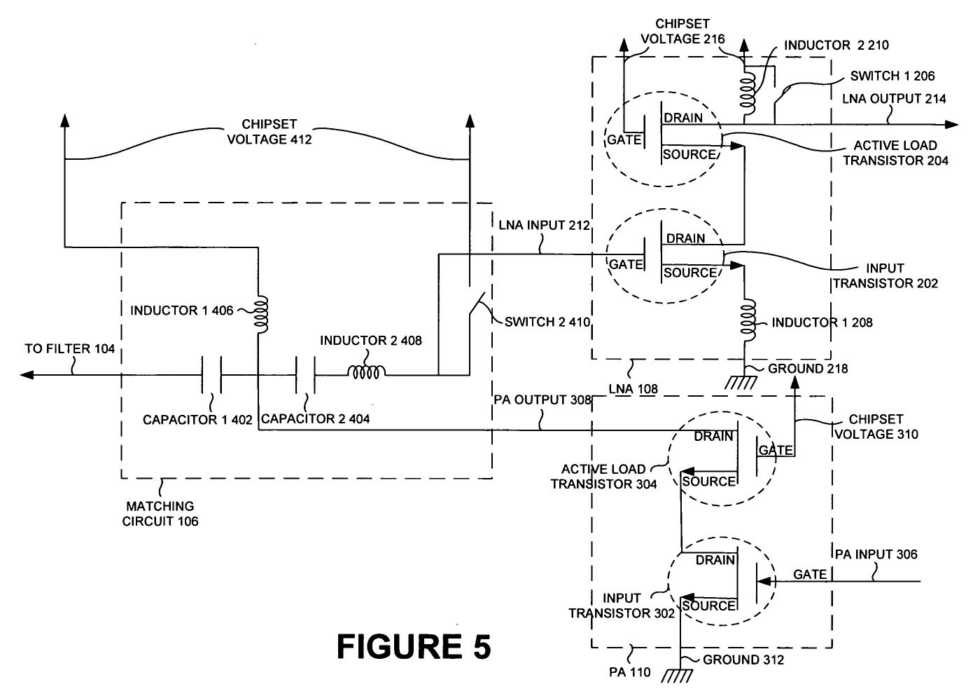

FIG. 5 is a circuit diagram of the matching circuit 106 of FIG. 1 connected with the low noise amplifier 108 and the power amplifier 110, according to one embodiment. In one example embodiment, a low noise amplifier (LNA) circuit of the wireless transceiver 100 of FIG. 1 may amplify an input signal to the wireless transceiver during a reception mode of the wireless transceiver. A power amplifier (PA) circuit of the wireless transceiver 100 may amplify an output signal of the wireless transceiver during a transmission mode of the wireless transceiver. Also, a matching circuit (e.g., which includes two capacitors, a first inductor coupled to the two capacitors in parallel, and a second inductor coupled to the two capacitors in series) of the wireless transceiver 100 may concurrently match an impedance of the low noise amplifier (e.g., which includes an input transistor of the low noise amplifier and an inductor coupled to the input transistor to form a real part of the 50 ohms) and the power amplifier with an impedance of an antenna circuit (e.g., 50 ohms) associated with the wireless transceiver such that a power of the input signal is maximized during the reception mode and a power of the output signal is maximized during the transmission mode.

An inductance due to a package bondwire of the wireless transceiver may be considered in selecting the two capacitors, the first inductor, and the second inductor. A first digital switch of the low noise amplifier may be closed to reduce a gain of the low noise amplifier (e.g., which draws less than 1 mili-amps of the output signal during the transmission mode) due to the output signal of the power amplifier strayed to the low noise amplifier during the transmission mode. A second digital switch of the power amplifier may be closed during the transmission mode to reduce the output signal of the power amplifier strayed to the low noise amplifier.

The low noise amplifier may be substantially isolated from the power amplifier when the first digital switch and the second digital switch are closed during the transmission mode. Also, the power amplifier circuit in an off-state may be substantially isolated from the low noise amplifier circuit during the reception mode when an impedance of the power amplifier circuit approaches an extremely high value relative to an impedance of the low noise amplifier.

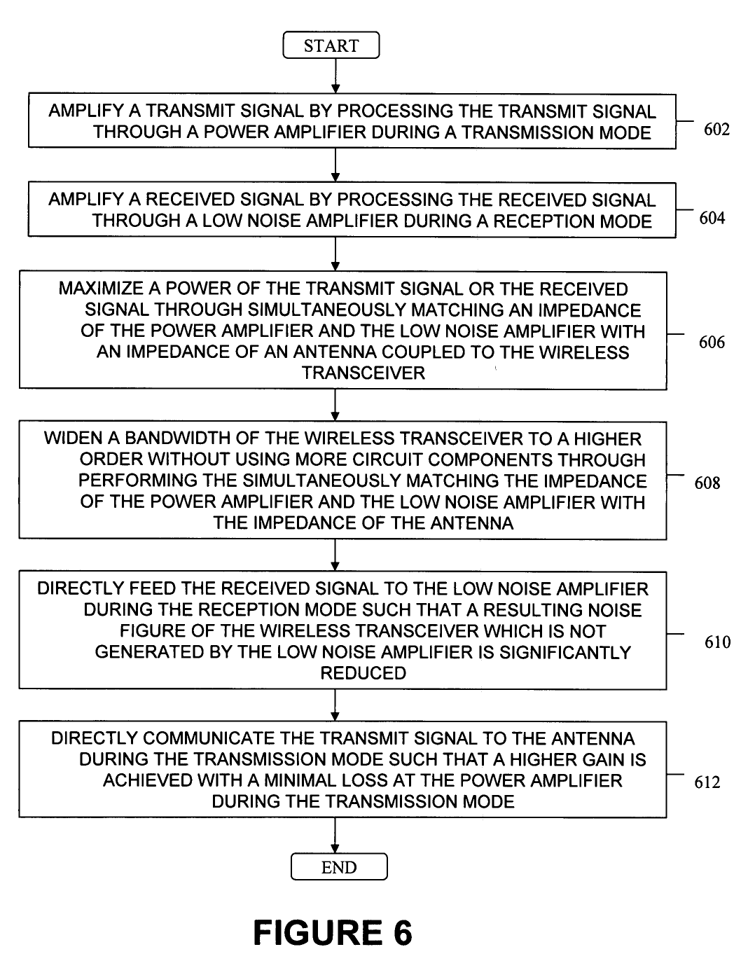

FIG. 6 is a process flow chart of maximizing a power of a signal processed through the wireless transceiver 100 of FIG. 1 by an impedance matching, according to one embodiment. In operation 602, a transmit signal (e.g., the PA output 308 of FIG. 3) may be amplified by processing the transmit signal through a power amplifier (e.g., the power amplifier 110 of FIG. 1) of a wireless transceiver (e.g., the wireless transceiver 100) during a transmission mode. In operation 604, a received signal (e.g., the LNA input 212 of FIG. 2) may be amplified by processing the received signal through a low noise amplifier (e.g., the low noise amplifier 108) during a reception mode. In operation 606, a power of the transmit signal and/or the received signal may be maximized through simultaneously matching an impedance of the power amplifier and the low noise amplifier with an impedance of an antenna (e.g., the antenna 102) coupled to the wireless transceiver.

In operation 608, a bandwidth of the wireless transceiver may be widened to a higher order without using more circuit components through performing the simultaneously matching the impedance of the power amplifier and the low noise amplifier with the impedance of the antenna, wherein the higher order to include at least the fourth order. In operation 610, the received signal may be directly fed to the low noise amplifier during the reception mode such that a noise figure of the wireless transceiver which is not generated by the low noise amplifier is significantly reduced (e.g., to a resulting noise figure between 4 dB and 5 dB). In operation 612, the transmit signal may be directly communicated to the antenna during the transmission mode such that a higher gain (e.g., about 28 dB) is achieved with a minimal loss at the power amplifier during the transmission mode. Also an output 1 dB compression point during the transmission mode may be greater than −3 dB.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. An impedance matching circuit of a wireless transceiver, comprising:
a low noise amplifier (LNA) circuit to amplify an input signal to the wireless transceiver during a reception mode of the wireless transceiver;
a power amplifier (PA) circuit to amplify an output signal of the wireless transceiver during a transmission mode of the wireless transceiver; and
a matching circuit to concurrently match an impedance of the low noise amplifier circuit and the power amplifier circuit with an impedance of an antenna circuit associated with the wireless transceiver such that a power of the input signal is maximized during the reception mode and a power of the output signal is maximized during the transmission mode.

2. The impedance matching circuit of claim 1, wherein the impedance of the antenna circuit is 50 ohms.

3. The impedance matching circuit of claim 2, further comprising an input transistor of the low noise amplifier circuit and an inductor coupled to the input transistor to form a real part of the 50 ohms.

4. The impedance matching circuit of claim 3, wherein the matching circuit to include two capacitors, a first inductor coupled to the two capacitors in parallel, and a second inductor coupled to the two capacitors in series.

5. The impedance matching circuit of claim 4, wherein an inductance due to a package bondwire of the wireless transceiver is considered in selecting the two capacitors, the first inductor, and the second inductor.

6. The impedance matching circuit of claim 1, further comprising a first digital switch of the low noise amplifier circuit to reduce a gain of the low noise amplifier circuit due to the output signal of the power amplifier circuit strayed to the low noise amplifier circuit during the transmission mode through closing the first digital switch.

7. The impedance matching circuit of claim 6, further comprising a second digital switch of the power amplifier circuit to reduce the output signal of the power amplifier circuit strayed to the low noise amplifier circuit when the second digital switch is closed during the transmission mode.

8. The impedance matching circuit of claim 7, wherein the low noise amplifier circuit to draw less than 1 mili-amps of the output signal during the transmission mode.

9. The impedance matching circuit of claim 8, wherein the low noise amplifier circuit is substantially isolated from the power amplifier circuit when the first digital switch and the second digital switch are closed during the transmission mode.

10. The impedance matching circuit of claim 9, wherein the power amplifier circuit in an off-state is substantially isolated from the low noise amplifier circuit during the reception mode when an impedance of the power amplifier circuit approaches an extremely high value relative to an impedance of the low noise amplifier.

11. A method of a wireless transceiver, comprising:
amplifying a transmit signal by processing the transmit signal through a power amplifier during a transmission mode;
amplifying a received signal by processing the received signal through a low noise amplifier during a reception mode; and
maximizing a power of at least one of the transmit signal and the received signal through simultaneously matching an impedance of the power amplifier and the low noise amplifier with an impedance of an antenna coupled to the wireless transceiver.

12. The method of claim 11, further comprising widening a bandwidth of the wireless transceiver to a higher order without using more circuit components through performing the simultaneously matching the impedance of the power amplifier and the low noise amplifier with the impedance of the antenna, wherein the higher order to include at least the fourth order.

13. The method of claim 12, further comprising directly feeding the received signal to the low noise amplifier during the reception mode such that a noise figure of the wireless transceiver which is not generated by the low noise amplifier is significantly reduced.

14. The method of claim 13, wherein the noise figure is between 4 dB and 5 dB.

15. The method of claim 14, wherein a gain of the low noise amplifier during the reception mode is about 28 dB.

16. The method of claim 15, further comprising directly communicating the transmit signal to the antenna during the transmission mode such that a higher gain is achieved with a minimal loss at the power amplifier during the transmission mode.

17. The method of claim 16, wherein an output 1 dB compression point during the transmission mode is greater than −3 dB.

18. The method of claim 17, further comprising decreasing a power consumption of the wireless transceiver by at least 5 percent through performing the simultaneously matching the impedance of the power amplifier and the low noise amplifier with the impedance of the antenna coupled to the wireless transceiver.

19. A system of a wireless transceiver, comprising:
a transmission circuit having a power amplifier (PA) to communicate a transmit signal of the wireless transceiver during a transmission mode of the wireless transceiver;
a reception circuit having a low noise amplifier (LNA) to communicate a received signal to the wireless transceiver during a reception mode of the wireless transceiver; and
a matching circuit to perform at least one of matching an impedance of the power amplifier with an impedance of an antenna of the wireless transceiver during the transmission mode to maximize a power of the transmit signal and matching an impedance of the low noise amplifier with the impedance of the antenna to maximize a power of the received signal.

20. The system of claim 19, wherein at least one of the power amplifier, the low noise amplifier, and the matching circuit to have a combination of capacitors and inductors such that the impedance of the power amplifier, the impedance of the low noise amplifier, and the impedance of the matching circuit are easily configurable.
